(19) United States
(12) Patent Application Publication
(10) Pub. No.: US 2003/0033436 A1
(43) Pub. Date: Feb. 13, 2003

(54) Method for statistical regression using ensembles of classification solutions

(76) Inventor: Sholom M. Weiss, New York, NY (US)

Correspondence Address: McGuireWoods LLP, Suite 1800, 1750 Tysons Boulevard, Tysons Corner, McLean, VA, 22102-3915, US

(21) Appl. No.: 09/853,620

(22) Filed: May 14, 2001

(51) Int. Cl. G06F 9/00; G06F 9/54; G06F 15/163

(52) U.S. Cl. 709/310

(57) ABSTRACT

A pattern recognition method induces ensembles of decision rules from data regression problems. Instead of direct prediction of a continuous output variable, the method discretizes the variable by k-means clustering and solves the resultant classification problem. Predictions on new examples are made by averaging the mean values of classes with votes that are close in number to the most likely class.

### BACKGROUND OF THE INVENTION

1. Field of the Invention

The present invention generally relates to the art of pattern recognition and, more particularly, to a method that induces ensembles of decision rules from data for regression problems. The invention has broad general application to a variety of fields, but has particular application to estimating manufacturing yields and insurance risks.

1. Background Description

There is a continuing effort to improve manufacturing yields in the production of a variety of products. For example, in the manufacture of laptop computer liquid crystal display (LCD) screens, the screens are produced in lots of 100. The yield is the percentage of screens produced error-free. The objective is to find prediction rules for yield as a continuous ordered real number. The patterns (rules) for the higher yields could be compared to those for the lower yields.

In the art of estimating insurance risk, customer attributes are recorded and the historical records are used to project expected gains and losses. For, example, the expected loss for insuring an individual can be estimated from historical customer data.

Prediction methods fall into two categories of statistical problems: classification and regression. For classification, the predicted output is a discrete number, a class, and performance is typically measured in terms of error rates. For regression, the predicted output is a continuous variable, and performance is typically measured in terms of distance, for example mean squared error or absolute distance.

In the statistics literature, regression papers predominate, whereas in the machine learning literature, classification plays the dominant role. For classification, it is not unusual to apply a regression method, such as neural nets trained by minimizing squared error distance for zero or one outputs. In that restricted sense, classification problems might be considered a subset of regression methods.

A relatively unusual approach to regression is to discretize the continuous output variable and solve the resultant classification problem. S. Weiss and N. Indurldiya in “Rule-based machine learning methods for functional prediction”, Journal of Artificial Intelligence Research, 3, pp. 383-403, 1995, describe a method of rule induction that used k-means clustering to discretize the output variable into classes. The classification problem was then solved in a standard way, and each induced rule had as its output value the mean of the values of the cases it covered in the training set. A hybrid method was also described that augmented the rule representation with stored examples of each rule, resulting in reduced error for a series of experiments.

Since that earlier work, very strong classification methods have been developed that use ensembles of solutions and voting. See L. Breiman, “Bagging predictors”, “Machine Learning, 24, pp. 123-140 (1996);. E. Bauer and R. Kohavi, “An empirical comparison of voting classification algorithms: Bagging, boosting and variants”, Machine Learning, 36, pp. 105-139 (1999); W. Cohen and Y. Singer, “A simple, fast, and effective rule learner”, Proceedings of Annual Conference of American Association for Artificial Intelligence, pp. 335-342 (1999); and S. Weiss and N. Indurkhya, “Lightweight rule induction”, Proceedings of the Seventeenth International Conference on Machine Learning, pp. 1135-1142 (2000). Ensemble learning methods generate many different classification decision rules for the same problem, for example by using different samples of data. A new example is classified by voting the results of the different decision rules. The decision rules can be generated by any complete pattern recognition method, for example, trees, logical rules or linear solutions. In light of the newer methods, we reconsider solving a regression problem by discretizing the continuous output variable using k-means and solving the resultant classification problem. The mean or median value for each class is the sole value to be stored as a possible answer when that class is selected as an answer for a new example.

Classification error can diverge from distance measures used for regression. Hence, we adapt the concept of margins in voting for classification (R. Schapire, Y. Freund, P. Bartlett, and W. Lee, “Boosting the margin: A new explanation for the effectiveness of voting methods”, Proceedings of the Fourteenth International Conference on Machine Learning, pp. 322-330, Morgan Kaufinann, 1998) to regression where, analogous to nearest neighbor methods for regression, class means for close votes are included in the computation of the final prediction.

Why not use a direct regression method instead of the indirect classification approach? Of course, that is the mainstream approach to boosted and bagged regression (J. Friedman, T. Hastie and P. Tibshirani, “Additive logistic regression: A statistical view of boosting”, Technical Report 1998, Stanford University Statistics Department. www.stat-stanford.edu/-tibs). Some methods, however, are not readily adaptable to regression in such a direct manner. Many methods that learn from data generate rules sequentially class by class.

### SUMMARY OF THE INVENTION

It is therefore an object of the present invention to provide a pattern recognition method that induces ensembles of decision rules from data for regression problems.

Instead of direct prediction of a continuous output variable, the method discretizes the variable by k-means clustering and solves the resultant classification problem. Predictions on new examples are made by averaging the mean values of classes with votes that are close in number to the most likely class.

A preprocessing step is used to discretize the predicted continuous variable. If good results can be obtained with a small set of discrete values, then the resultant solution can be far more elegant and possibly more interesting to human observers. Lastly, just as experiments have shown that discretizing the input variables may be beneficial, it may be interesting to gauge experimental effects of discretizing the output variable. To use a classification method for regression requires an additional data preparation step to discretize the continuous output. The final prediction involves the use of marginal votes.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a flow diagram illustrating the process of determining the number of classes; and

FIG. 2 is a flow diagram illustrating the process of regression using ensemble classifiers.

### DETAILED DESCRIPTION OF A PREFERRED EMBODIMENT OF THE INVENTION

Although the predicted variable in regression may vary continuously, for a specific application, it is not unusual for the output to take values from a finite set, where the connection between regression and classification is stronger. The main difference is that regression values have a natural ordering, whereas for classification the class values are unordered. This affects the measurement of error. For classification, predicting the wrong class is an error no matter which class is predicted (setting aside the issue of variable misclassification costs). For regression, the error in prediction varies depending on the distance from the correct value. A central question in doing regression via classification is the following. Is it reasonable to ignore the natural ordering and treat the regression task as a classification task?

The general idea of discretizing a continuous input variable is well studied (J. Dougherty, R. Kohavi, and M. Sahami, “Supervised and unsupervised discretization of continuous features”, Proceedings of the 12th International Conference on Machine Learning, pp. 194-202, 1995); the same rationale holds for discretizing a continuous output variable. K-means (medians) clustering (J. Hartigan and M. Wong, “A k-means clustering algorithm, ALGORITHM AS 136“, Applied Statistics, 28, 1979) is simple and effective approach for clustering the output values into pseudo-classes. The values of the single output variable can be assigned to clusters in sorted order, and then reassigned by k-means to adjacent clusters. To represent each cluster by a single value, the cluster's mean value minimizes the squared error, while the median minimizes the absolute deviation.

How many classes/clusters should be generated? Depending on the application, the trend of the error of the class mean or median for a variable number of classes can be observed, and a decision made as to how many clusters are appropriate. Too few clusters would imply an easier classification problem, but puts an unacceptable limit on the potential performance; too many clusters might make the classification problem too difficult. For example, Table 1 shows the global mean absolute deviation (MAD) for a typical application as the number of classes is varied. The MAD will continue to decrease with increasing number of classes and reach zero when each cluster contains homogeneous values. So one possible strategy might be to decide if the extra classes are worth the gain in terms of a lower MAD. For instance, one might decide that the extra complexity in going from 8 classes to 16 classes is not worth the small drop in MAD.

TABLE 1
Variation in Error with Number of Classes

| Classes | 1 | 2 | 4 | 8 | 16 | 32 | 64 | 128 |
|---|---|---|---|---|---|---|---|---|
| MAD | 4.0538 | 2.3432 | 1.2873 | 0.6795 | 0.3505 | 0.1784 | 0.0903 | 0.0462 |
| SE | .0172 | .0105 | .0061 | .0035 | .0019 | .0011 | .0006 | .0004 |

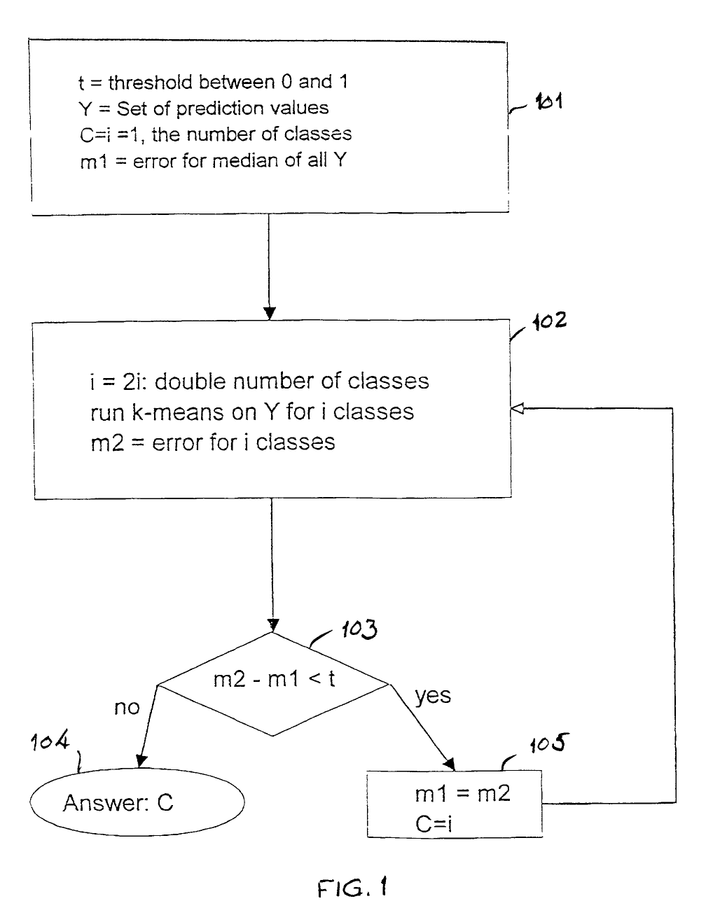

FIG. 1 shows a simple procedure to analyze the trend using Table 1 and determine the appropriate number of classes. The process begins with an initialization step 101 in which t is set to a threshold value between 0 and 1, Y is input as the set of prediction values, C, the number of classes, is indexed (i) to 1, and error for median of all Y is set to ml. The procedure then enters a processing loop where, in function block 102, the number of classes is doubled, i.e., i=2i. In addition, k-means is run on Y for i classes, and m₂ is computed as the error for i classes. A determination is made in decision block 103 as to whether the difference of m₂ and m₁ is less than t. If not, the answer is output as C in output block 104; otherwise, m₁ is set to equal m₂ and C to i in function block 105, and the process loops back to function block 102.

The basic idea is to double the number of classes, run k-means on the output variable, and stop when the reduction in the MAD from the class medians was less than a certain percentage of the MAD from using the median of all values. This percentage is adjusted by the threshold, t. In our experiments, for example, we fixed this to be 0.1 (thereby, requiring that the reduction in MAD be at least 10%). Besides the predicted variable, no other information about the data is used. If the number of unique values is very low, it is worthwhile to also try the maximum number of potential classes. In our experiments, we found that this was beneficial when there were not more than 30 unique values.

The pseudocode for this procedure is given below:

Determining the Number of Classes

Input: t, a user-specified threshold (0<t<1)

Y={yᵢ, i=1 . . . n}, the set of n predicted values in the training set

Output: C the number of classes

M₁:=mean absolute deviation (MAD) of yᵢ from Median(Y)

min−gain:=t·M₁

i:=1

repeat

C:=i

i:=2·i

run k-means clustering on Y for i clusters

M₁:=MAD of yᵢ from Median(Cluster(yᵢ))

Until M_{i/2}−Mᵢ≦min−gain

output C

Besides helping decide the number of classes, Table 1 also provides an upper bound on performance. For example, with sixteen classes, even if the classification procedure were to produce 100% accurate rules that always predicted the correct class, the use of the class median as the predicted value would imply that the regression performance could at best be 0.3505 on the training cases. This bound can be also be a factor in deciding how many classes to use.

Within the context of regression, once a case is classified, the a priori mean or median value associated with the class can be used as the predicted value. Table 2 gives a hypothetical example of how 100 votes are distributed among four classes. Class 2 has the most votes; the output prediction would be 2.5.

TABLE 2
Voting with Margins

| Class | Votes | Class-Mean |
|---|---|---|
| 1 | 10 | 1.2 |
| 2 | 40 | 2.5 |
| 3 | 35 | 3.4 |
| 4 | 15 | 5.7 |

An alternative prediction can be made by averaging the votes for the most likely class with votes of classes close to the best class. In the example above, if one allows for classes with votes within 80% of the best vote to also be included, then besides the top class (class 2), class 3 need also be considered in the computation. A simple average would result in the output prediction being 2.95, and the weighted average, which we use in the experiments, gives an output prediction of 2.92.

The use of margins here is analogous to nearest neighbor methods where a group of neighbors will give better results than a single neighbor. Also, this has an interpolation effect and compensates somewhat for the limits imposed by the approximation of the classes by means.

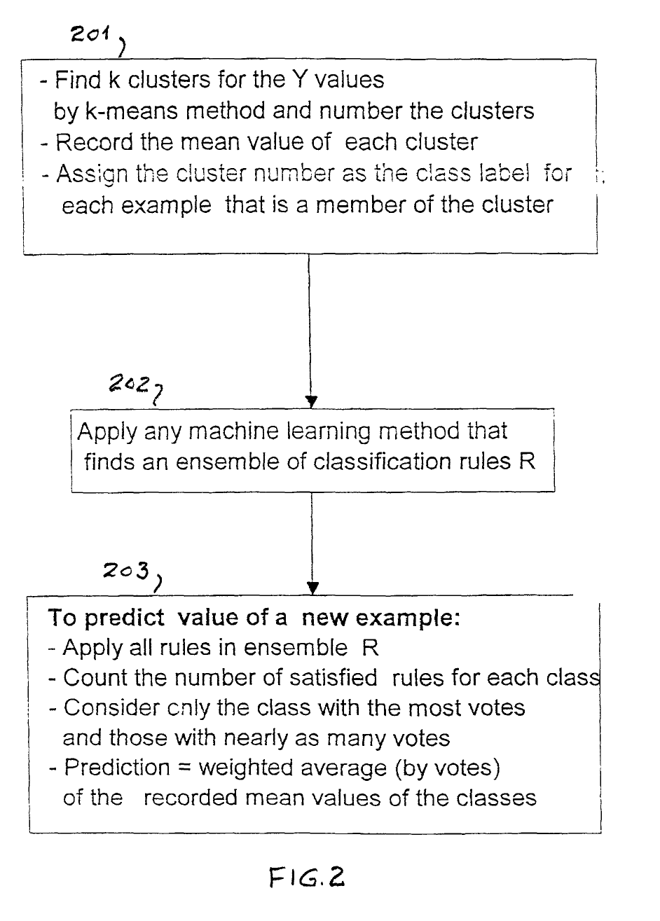

The overall regression procedure is summarized in FIG. 2 for k classes, n training cases, median (or mean) value of class j, mⱼ, and a margin of M. The key steps are the generation of the classes, generation of rules, and using margins for predicting output values for new cases. The process begins in function block 201 where k clusters are found for the Y values by k-means method, and the clusters are numbered. In addition, the mean value of each cluster is recorded, and the cluster number is assigned as a class label for each example that is a member of the cluster. Then, in function block 202, any machine learning method is applied to find an ensemble of classification rules R. Finally, in function block 203, the value of a new example is predicted by applying all rules in ensemble R, counting the number of satisfied rules for each class, considering only the class with the most votes and those with nearly as many votes, and making the prediction as a weighted average (by votes) of the recorded mean values of the classes.

To summarize, the regression using ensemble classifiers illustrated in FIG. 2 proceeds as follows:

1. run k-means clustering for k clusters on the set of values {Yᵢ, i=1 . . . n}

2. record the mean value mⱼ of the cluster c₁ for j=1 . . . k

3. transform the regression data into classification data with the class label for the i-th case being the cluster number of yᵢ

4. apply ensemble classifier and obtain a set of rules R

5. to make a prediction for new case u, using a margin of M (where 0≦M≦1):

(a) apply all the rules R on the new case u

(b) for each class i, count the number of satisfied rules (votes) vᵢ

(c) class t has the most votes, vₜ

(d) consider the set of classes P={p} such that vₚ≧M·vᵢ

(e) the predicted output for case u,

$${y}_{u}^{′} = \frac{{\sum }_{j ∈ p} {m}_{j} {v}_{j}}{{\sum }_{j ∈ p} {v}_{j}}$$

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A method for statistical regression using ensembles of classification solutions comprising the steps of:
running k-means clustering for k clusters on the set of values {yₗ,i=1 . . . n};
recording a mean value mⱼ of a cluster cⱼ for j=1 . . . k;
transforming regression data into classification data with a class label for an i-th case being a cluster number of yᵢ;
applying ensemble classifier and obtain a set of rules R; and
making a prediction for new case u, using a margin of M, where 0≦M≦1.

2. The method recited in claim 1, wherein the step of making a prediction comprises the steps of:
applying all the rules R on the new case u;
for each class i, counting a number of satisfied rules (votes) vᵢ;
classifying t has the most votes, vₗ;
considering a set of classes P={p} such that vₚ≧M·vₜ; and
generating a predicted output for case u,
$${y}_{u}^{′} = \frac{{\sum }_{j ∈ p} {m}_{j} {v}_{j}}{{\sum }_{j ∈ p} {v}_{j}} .$$

3. A method of pattern recognition comprising the steps of:
applying clustering processes to determine a number of classes;
applying ensemble learning classification processes to predict most likely classes for a new example; and
then averaging regression values of most likely classes to predict a value of a new example.

4. A method of pattern recognition for a set of values, said method comprising the steps of:
determining a number of classes to be generated based on a trend of error of a class mean/median for the set of values;
classifying the values using ensemble learning classification and the determined number of classes;
generating a set of classification rules; and
averaging regression values of most likely classes to predict a value of a new example based on the set of rules.

5. A method of pattern recognition according to claim 4, wherein said step of determining a number of classes comprises the steps of:
determining the class mean/median for a variable number of classes;
determining a mean absolute deviation (MAD) based on the class means/medians; and
comparing the MAD to a predetermined percentage of MAD.

6. A method of pattern recognition according to claim 4, wherein the step of averaging regression values includes using margins for predicting the value of the new example.

7. A method of pattern recognition according to claim 4, wherein the step of averaging regression values comprises the steps of:
applying the set of classification rules to the new example;
for each class i, counting a number of satisfied rules (votes) vᵢ;
classifying t has the most votes, vₗ;
considering a set of classes P={p} such that vₚ≧M·vₗ; and
generating a predicted output for case u,
$${y}_{u}^{′} = \frac{{\sum }_{j ∈ p} {m}_{j} {v}_{j}}{{\sum }_{j ∈ p} {v}_{j}} .$$
